(19) United States
(12) Patent Application Publication
(10) Pub. No.: US 2008/0112008 A1
(43) Pub. Date: May 15, 2008

(54) PRINTING APPARATUS, METHOD OF CONTROLLING SAME, PROGRAM AND STORAGE MEDIUM

(75) Inventor: Makoto Kikugawa, Tokyo (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/929,394

(22) Filed: Oct. 30, 2007

(30) Foreign Application Priority Data
Nov. 15, 2006 (JP) 2006-309628

(51) Int. Cl. G06K 1/00

(52) U.S. Cl. 358/1.15

(57) ABSTRACT

A printing apparatus having a printing device for executing print processing based upon document data, comprises: an input unit adapted to input document data; a storage control unit adapted to store the input document data in a storage device; an authentication unit adapted to authenticate a user; a determination unit adapted to determine, for every user authenticated by the authentication unit, whether or not it is necessary to perform printing based upon the document data that has been stored in the storage device; a decision unit adapted to decide the number of copies of document data to be printed, based upon the determination made by the determination unit; and a printing control unit adapted to cause the printing device to execute printing of the decided number of copies with regard to the document data that has been stored in the storage device.

### BACKGROUND OF THE INVENTION

1. Field of the Invention

The present invention relates to a printing apparatus, a method of controlling the apparatus, a program and a storage medium.

2. Description of the Related Art

Consider the circumstances involved in preparing conference materials. In particular, consider the circumstances involved in preparing conference materials not for a conference in which the conferees have been decided in advance but for a conference in which it is difficult to predict the conferees. An example of such a conference is one in which individuals for which attendance is convenient on the day of the conference gather and have a discussion in order to review a technology. What is generally needed in such case is a forecast of the number of conferees and the preparation of conference materials of the required number of copies. A variety of methods of preparing conference materials in such circumstances are known. The following are examples:

(1) The organizer of the conference predicts the number of conferees and prepares the necessary number of copies of conference materials manually.

(2) By using an in-house network, the conference materials are placed in a shared folder beforehand and it is so arranged that in accordance with an announcement from the conference organizer, individuals who plan to attend the conference can each use their own personal computers to access the shared folder containing the materials. In this case, each individual planning to attend prints out the conference materials and brings them to the conference in the form of paper printouts or loads the conference materials in a notebook personal computer in the form of electronic data and brings the personal computer to the conference. Thus, each participant is made to prepare the conference materials in advance.

(3) When a participant enters the conference room, whether the participant is a previously registered individual who plans to attend the conference is sensed as by an ID card possessed by the participant, the number of attendees who have been registered as conferees is detected and conference materials for this number of conferees are prepared by being printed before the start of the conference. In accordance with this arrangement, the materials to be prepared are printed in the appropriate number of copies (e.g., see the specification of Japanese Patent Application Laid-Open No. 2004-38886).

(4) Furthermore, a network-compatible multi-function peripheral (referred to as an “MFP” below) is placed in the conference room and the required number of copies of materials can be printed using the MFP. In this case, when a participant carrying a notebook personal computer enters the conference room, a device such as an IC card bearing participant authentication information is made to communicate with an admission reader or with an authentication device of the MFP, whereby the participant is authenticated. The participant then connects his or her notebook personal computer to the network. The MFP creates a shared folder, which is restricted to the conference, for the purpose of saving materials created for the conference, and the participant carrying his or her own personal computer can access the shared folder. On the other hand, the manager of the conference materials who has connected to the network and can access the shared folder places the conference materials, which have been prepared just prior to the start of the conference, in the shared folder. As a result, a conferee who has brought his or her own personal computer can access the shared folder and obtain the conference materials. Further, with regard to conference materials prepared by being printed out on paper rather than being placed in the form of electronic information, the paper printout is read in from the reader (scanner) of the MFP, converted to electronic information and then placed in the shared folder. As a result, by arranging it so that the shared folder is accessed from each individual personal computer, each participant can obtain the conference materials without the conference organizer making unnecessary output of conference materials and without fear of insufficient copies of the materials.

In arrangement (4) above, the personal computer brought by the participant is connected to the network, the core of which is the MFP, after the participant has his or her admission authenticated by the MFP, thereby allowing the participant to access the shared conference folder created within the MFP. This means that each individual can obtain the conference materials immediately before the start of the conference without the need for preparations such as the placing of the materials, which have been brought to the conference, in the folder. Since printing on paper is not carried out, the materials can be viewed appropriately without problems concerning too many or too few copies.

However, there are instances where the following problems arise when conference materials are prepared upon predicting the amount thereof by the conventional methods described above:

With method (1), there are cases where conference materials are wasted by being created superfluously. Conversely, there are cases where the required amount of conference materials is not prepared because too few are created owing to concern that too many will be produced. In the latter case, there are instances where the conference organizer is constrained to make additional copies. This can bring the conference to a halt and detract from the efficiency of the conference.

With method (2), it is conceivable that there will be attendees who are busy prior to the conference and must attend the conference without having the opportunity to prepare the materials in advance. Consequently, the conference organizer ultimately must guess the number of attendees and prepare the conference materials. Accordingly, even if the conference materials are placed in a shared folder beforehand, there is a possibility that the problem of too many or too few prepared conference materials will arise.

Further, in a case where a plurality of individuals prepare conference materials, time for preparation may last until just prior to the start of the conference and there may be materials which cannot be placed in the shared folder beforehand and which each participant cannot be made to print out. At such time the organizer must prepare the materials by printing them and there is the possibility that the above-described problem relating to number of copies will arise.

With method (3), materials that have been prepared in a shared folder beforehand are printed in an amount commensurate with participants who have prepared the materials for perusal using their personal computers upon loading the materials in their personal computers in advance. Hence there is the possibility that unnecessary copies will be printed out in a manner similar to (2) above.

With method (4), it is assumed that all conferees have brought personal computers. This means that it is necessary to print the conference materials for those conferees who have not brought personal computers. Accordingly, the conference organizer is still required to predict the number of participants who will attend without personal computers and to manage the printing of conference materials of the optimum number of copies.

### SUMMARY OF THE INVENTION

Accordingly, the present invention has been devised in view of the foregoing problems and its object is to provide a technique whereby it is made possible to print the necessary number of copies of documents without requiring troublesome labor even in a case where the required number of documents is unknown beforehand.

According to one aspect of the present invention, a printing apparatus having a printing device for executing print processing based upon document data, comprises:

an input unit adapted to input document data;

a storage control unit adapted to store the input document data in a storage device;

an authentication unit adapted to authenticate a user;

a determination unit adapted to determine, for every user authenticated by the authentication unit, whether or not it is necessary to perform printing based upon the document data that has been stored in the storage device;

a decision unit adapted to decide the number of copies of document data to be printed, based upon the determination made by the determination unit; and

a printing control unit adapted to cause the printing device to execute printing of the decided number of copies with regard to the document data that has been stored in the storage device.

According to another aspect of the present invention, a method of controlling a printing apparatus having a printing device for executing print processing based upon document data, the method comprises:

inputting document data;

storing the input document data in a storage device;

authenticating a user;

determining, for every authenticated user, whether or not it is necessary to perform printing based upon the document data that has been stored in the storage device;

deciding the number of copies of document data to be printed, based upon the determination; and

causing the printing device to execute printing of the decided number of copies with regard to the document data that has been stored in the storage device.

Further features of the present invention will become apparent from the following description of exemplary embodiments with reference to the attached drawings.

### BRIEF DESCRIPTION OF THE DRAWINGS

FIG. 1 is a block diagram illustrating an example of the configuration of a system constituted by a digital copier;

FIG. 2 is a diagram illustrating in detail in the interior of an MFP;

FIG. 3 is a block diagram illustrating the details of the structure of a control unit;

FIG. 4 is a flowchart illustrating the flow of user operation and of processing by the arrangement of this embodiment;

FIG. 5 is a diagram exemplifying a user interface displayed on an operation unit;

FIG. 6 is a diagram schematically illustrating the flow of application for participation in a conference according to this embodiment;

FIG. 7 is a diagram exemplifying a list of participants;

FIG. 8 is a diagram schematically illustrating the manner in which mail is transmitted to a personal computer connected to a network;

FIG. 9 is a diagram schematically illustrating the manner in which the personal computer of a participant is capable of accessing a shared folder;

FIG. 10 is a diagram schematically illustrating the manner in which conference materials are placed in a shared folder;

FIG. 11 is a diagram schematically illustrating the flow of printing of materials executed by the arrangement according to this embodiment; and

FIG. 12 is a diagram schematically illustrating the relationship among conferees centered on an MFP.

### DESCRIPTION OF THE EMBODIMENTS

Preferred embodiments of the present invention will now be described in detail with reference to the accompanying drawings. It should be noted that the constituents described in this embodiment are exemplary and that the scope of the present invention is not limited solely to these constituents.

### First Embodiment

(Configuration of Image Forming System)

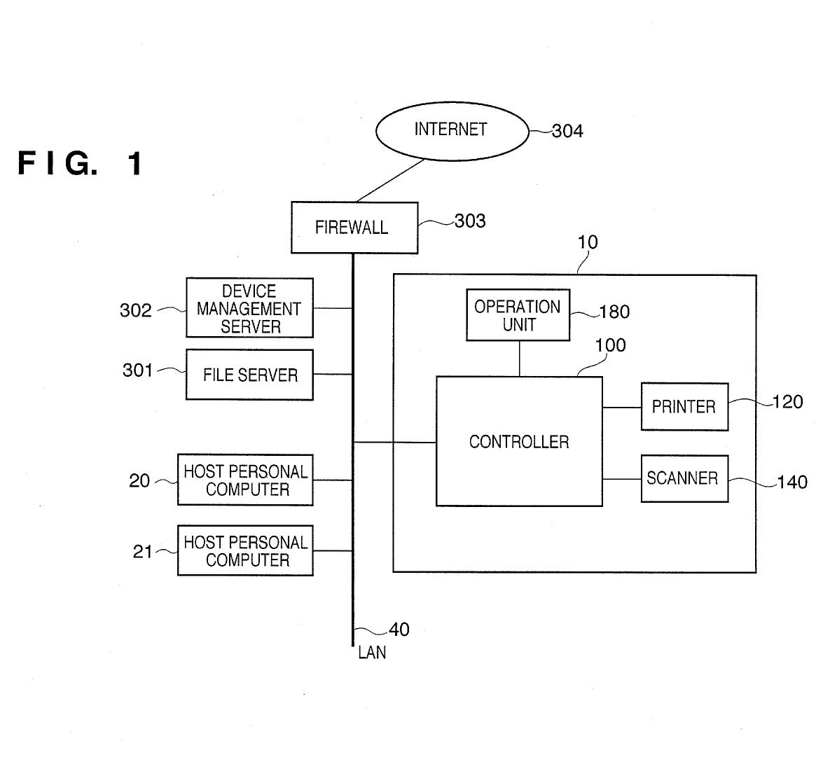

First, reference will be had to FIG. 1 to describe the configuration of an image forming system according to this embodiment. FIG. 1 is a block diagram illustrating an example of the configuration of a system that includes a digital copier in this embodiment.

The interior of a LAN 40 illustrated later and an external communication network (e.g., Internet 304) are connected by a firewall 303, which performs security management and the like.

A device management server 302 manages devices such as a digital copier 10, personal computers 20, 21 and a file server 301 connected by the LAN 40. The file server 301 makes it possible for a plurality of users, which are connected by the LAN 40, to share data.

The digital copier 10 (digital multifunction peripheral) mainly has an image input/output function. The digital copier 10 has an operation unit 180 for allowing users to perform various operations; an image scanner (reader) 140 for reading an image in accordance with a command from the operation unit 180 or host personal computers 20, 21; and a printer 120 for printing, on paper, data from the host personal computers 20, 21 or file server 301.

A controller 100 controls the input and output of image data to and from the scanner 140 and printer 120 based upon commands from the operation unit 180 and host personal computers 20, 21. For example, the controller 100 exercises control to store image data, which has been captured by the scanner 140, in a memory within the controller, to output this data to the host personal computers 20, 21 or to print the data using the printer 120.

It should be noted that although this embodiment is described assuming that the LAN 40 is a wired LAN, the LAN 40 is not limited to this arrangement. That is, irrespective of whether it is wired or wireless, it will suffice if the LAN 40 is a path capable of sending and receiving data, such as a public network (an analog network or ISDN, etc.), WAN or wireless LAN.

(Structure of MFP)

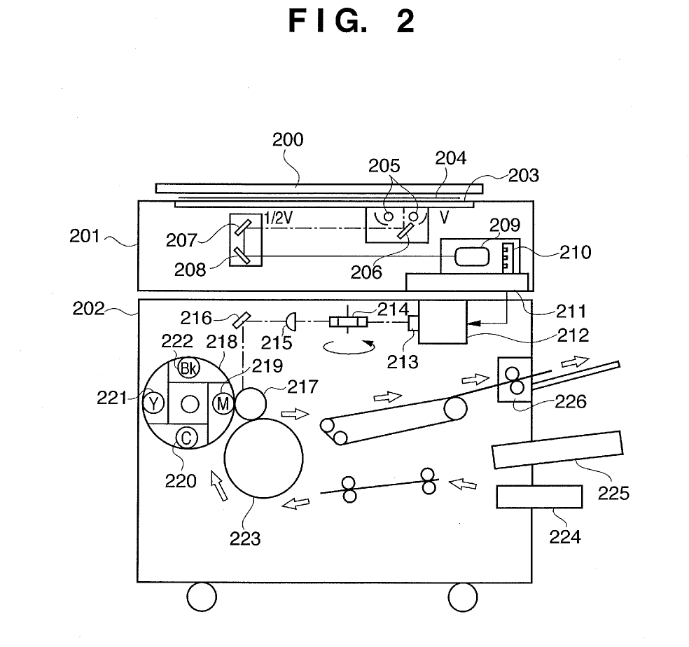

Next, the details of an MFP (multi-function peripheral) 200 will be described with reference to FIG. 2. FIG. 2 is a diagram illustrating the structure of the interior of the MFP 200. It should be noted that the digital copier 10 can be implemented by the MFP 200, by way of example. The digital copier 10 will be described below assuming that it is implemented by the MFP 200.

The MFP 200 in FIG. 2 is roughly divided into an image reader 201 for reading document images, and a printer 202 for reproducing image data that has been read by the image reader 201. The image reader 201 reads documents at a resolution of, e.g., 400 dpi (dots per inch) and executes digital image processing. The printer 202 prints an image, which corresponds to a document image read by the image reader 201, in full color on a specified paper at a resolution of 1200 dpi. A document 204 on a document glass (referred to as a “platen” below) in illuminated by lamps 205 in the image reader 201, and light reflected from the document is guided to mirrors 206, 207 and 208. An image is formed by a lens 209 on a three-line sensor (referred to as a “CCD” below) 210 that converts condensed light to an electric signal, and the electric signal is sent to an image processor 211 as red (R), green (G) and blue (B) components of full-color information. It should be noted that a carriage to which the lamps 205 and mirror 206 are fixed and the mirrors 207, 208 are moved mechanically at speeds of V and, e.g., V/2, respectively, in a direction perpendicular to the electrical scanning direction (main-scan direction) of the line sensor to thereby scan the full surface of the document (sub-scan direction).

The read image is stored in a memory, which is not shown. Next, the image data is read out of the memory again. The image processor 211 processes the read image signal electrically, breaks it down into magenta (M), cyan (C), yellow (Y) and black (Bk) components and sends these to the printer 202.

The M, C, Y and Bk image signals corresponding to the document image from the image reader 201 are sent to a laser driver 212. The laser driver 212 modulates and drives a semiconductor laser 213 in conformity with the transmitted image signals. The laser light is made to scan across a photosensitive drum 217 via a polygon mirror 214, f-θ lens 215 and mirror 216. A rotating developing device 218 is composed of a magenta developing unit 219, cyan developing unit 220, yellow developing unit 221 and black developing unit 222. These four developing units contact the photosensitive drum 217 alternatingly so that latent images that have been formed on the photosensitive drum 217 are developed by toner. Paper supplied from a paper cassette 224 or 225 is wound upon a transfer drum 223, whereby the image that has been developed on the photosensitive drum is transferred to the paper. After the four colors M, C, Y and Bk are thus transferred one after another, the paper is sent through a fixing unit 226 to fix the toner to the paper, after which the paper is ejected from the apparatus.

(Structure of Controller)

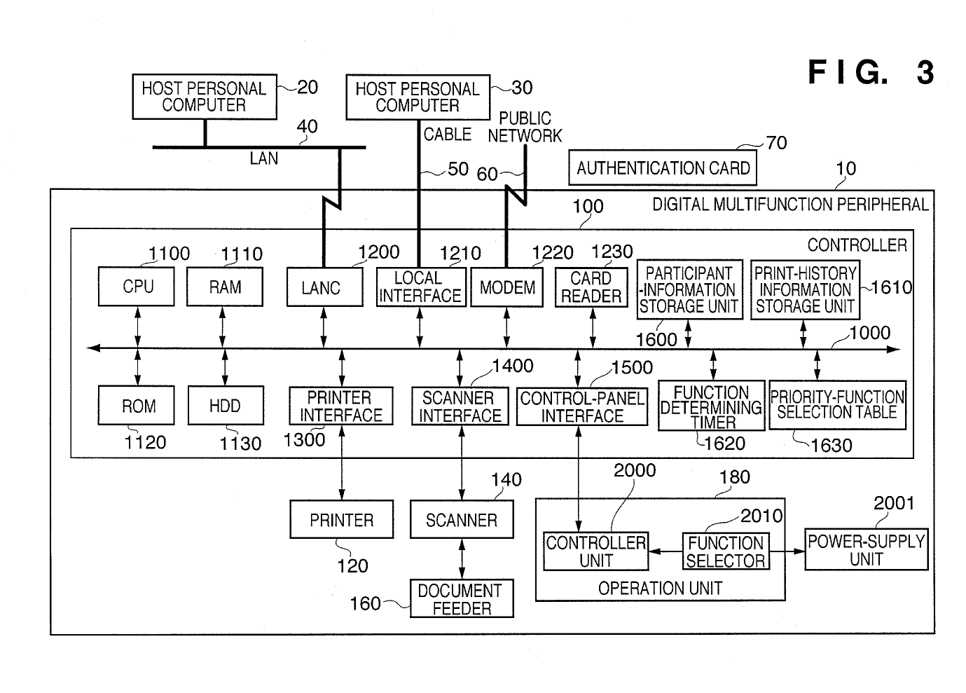

Next, the structure of the controller 100 of digital copier 10 (MFP 200) will be described in detail with reference to FIG. 3. FIG. 3 is a block diagram illustrating the structure of the controller 100 in detail.

The controller 100 is connected to the scanner 140 and printer 120 and controls the input and output of image information A CPU 1100 controls the various components constituting the controller.

A RAM 1110 is for temporarily storing the results of processing by the CPU 1100 and image data, etc., handled by the printer. Stored in a ROM 1120 are the program run by the CPU 1100 and font data, etc., for generating text image data.

Connected to a bus 1000 are the CPU 1100, RAM 1110, ROM 1120 and other functional components. The printer 120 forms an image on a printing medium such as paper. The printer 120 can be of the electrophotographic type described above or of another type, such as a bubble-jet printer.

A printer interface 1300 is for connecting the printer 120 to an input/output bus. It is possible for image data that has been stored in the RAM 1110 to be transferred to the printer 120 in accordance with a command from the printer interface 1300 or CPU 1100.

A hard-disk drive (HDD) 1130 is for spooling image data and storing programs by which the CPU 1100 executes various processing. Further, the hard-disk drive 1130 is used as an area in which information is stored as a shared folder, described later.

A network interface controller (LANC) 1200 is used to make a connection to the LAN 40.

A local interface 1210 is an interface circuit for allowing the host personal computer 30, etc., to communicate with the CPU 1100. The form of communication may be serial communication, communication using a Bicentro interface or wireless communication such as Bluetooth. The local interface 1210 receives for-output image data, which conforms to an input operation at the operation unit 180, from the host personal computer 30 or from a for-output image data management unit (not shown) on the network in response to the input operation at the operation unit 180.

A card reader interface 1230 (reading device) is an external interface capable of reading data from an authentication card (identification medium) 70 such as an IC card. The card reader interface 1230 may be made a removable-media interface (not shown) and it will suffice if the card reader can read out user data. That is, the medium on which data is recorded is not limited to a card. Information for specifying a user (user name or ID, etc.) and a mail address (which can be omitted), etc., are stored on the authentication card 70.

A function determining timer 1620 is for managing the time of scheduled functions. The timer sets and manages starting time for printing materials before a conference, described later. A participant-information storage unit 1600 stores, in correspondence, conferee names, mail addresses and information as to whether printing of conference materials is necessary or not.

A print-history information storage unit 1610 is a memory for storing a history of printing of participant-oriented conference materials that require printing. A control-panel interface 1500 is for interfacing an operation unit (UI) 180 and outputs image data, which is displayed on the operation unit 180, to the operation unit 180. The control-panel interface 1500 also functions to send the CPU 1100 information that the system user has input from the operation unit 180.

The operation unit 180 has a function selector 2010 that allows the user to select which function among copy, FAX, SEND and printer functions of the MFP 200 is to be started up preferentially. The function selector 2010 is connected to a power-supply unit 2001, which is adapted to turn on a power supply, and to the control-panel interface 1500.

The scanner (reader) 140 converts an optical signal read from a document placed on a platen (not shown) to electronic data using a CCD, etc., and transfers the electronic data.

A scanner interface 1400 connects the scanner with an input/output interface. In accordance with a command from CPU 1100, the scanner interface 1400 is capable of transferring electronic data, which has been transferred from the scanner and is the result of reading the document, to the RAM 1110.

(Example of Operation)

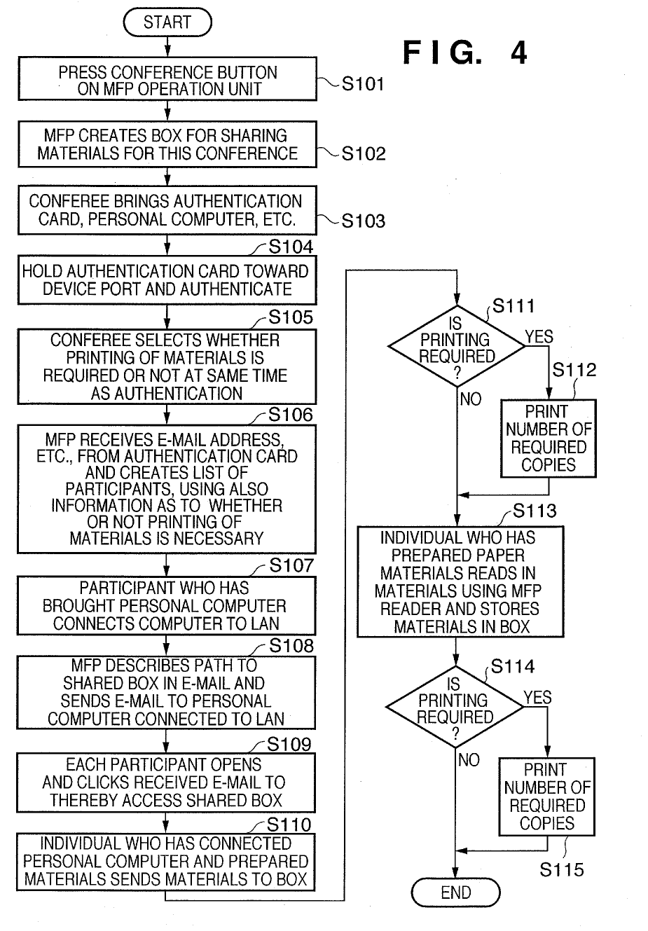

Next, reference will be had to FIG. 4 and other drawings to describe the flow of processing in the implementation according to this embodiment. FIG. 4 is a flowchart illustrating the flow of user operation and of processing by the arrangement of this embodiment. The user and the arrangement of this embodiment forward processing through the procedure set forth below.

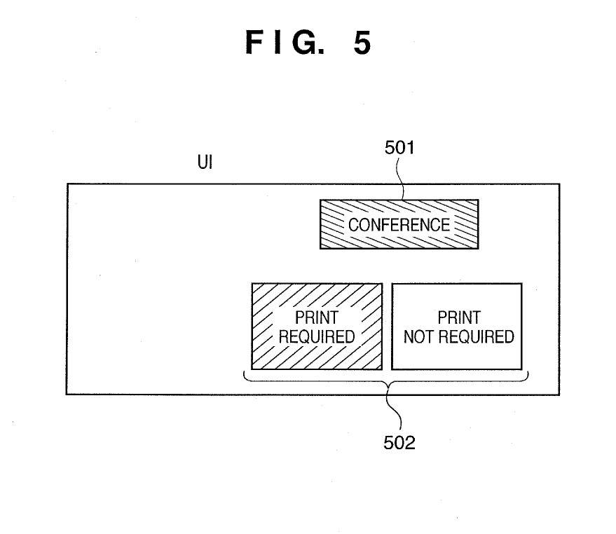

Step S101: The user selects a conference button on the operation unit 180 of the MFP 200 that has been installed in the conference room. FIG. 5 is a diagram exemplifying a user interface displayed on the operation unit 180. A conference button 501 accepts selection of a conference mode, and PRINT/DON'T PRINT buttons 502 accept a selection as to whether or not printing (PRINT) is required. Selection of the conference button 501 is accepted from the user at step S101.

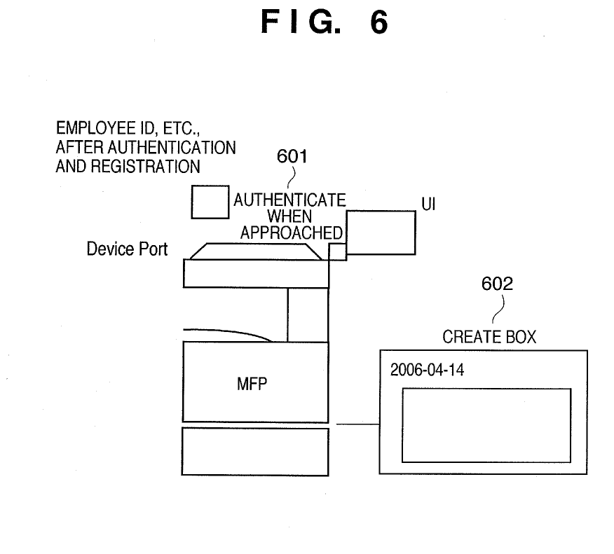

Step S102: The MFP 200, which has recognized the conference mode owing to selection of the conference button 501, creates a shared folder that is restricted to the particular conference. FIG. 6 is a diagram schematically illustrating the flow of application for participation in a conference according to this embodiment. When selection of the conference button 501 is accepted, the MFP 200 creates a box used as shared folder, as indicated at 602 in FIG. 6. The box is created in a storage device such as the hard-disk drive 1130.

Step S103: The conferee brings an authentication card and/or personal computer to the conference.

Step S104: The conferee allows a device communication unit of the MFP 200 to read the authentication card. That is, as indicated at 601 in FIG. 6, the MFP 200 reads conferee data from the authentication card via the device communication unit in response to insertion of or contact with the authentication card and authenticates this conferee. The data recognized also contains mail address information that allows the conferee to be notified.

Step S105: In response to authentication, a screen for selecting whether or not printing of conference materials is required is displayed and the conferee selects whether or not printing of conference materials is required. That is, in accordance with selection of the PRINT/DON'T PRINT buttons 502 (FIG. 5) forming part of the user interface displayed on the operation unit 180, the MFP 200 recognizes whether or not it is necessary to print the conference materials for the user authenticated at step S104.

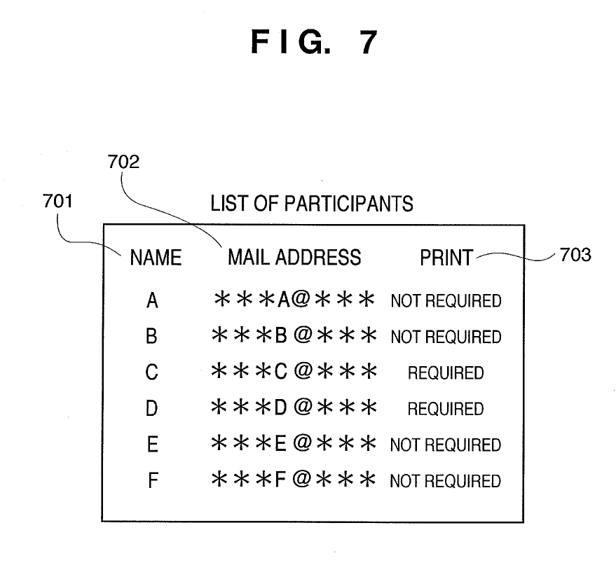

Step S106: The MFP 200 creates a list of participants based upon the authentication data acquired at step S104 and whether or not printing is required as recognized at step S105. FIG. 7 is a diagram exemplifying a list of participants. As illustrated in FIG. 7, the list of participants contains, e.g., participant names (or IDs or identification information for identifying the participants) 701, mail address information 702 and whether or not printing is required (703). The MFP 200 controls the storage of data (information), which indicates the participant list created, in the storage unit such as the hard-disk drive 1130.

Step S107: The participant, who has brought his or her personal computer, connects the personal computer to the network. That is, the personal computer is connected to the LAN 40 as the host 20 or 21 and sets up a state in which communication with the MFP 200 is possible. In the description that follows, it will be assumed that the personal computer brought by the participant and connected to the LAN 40 is the personal computer 20.

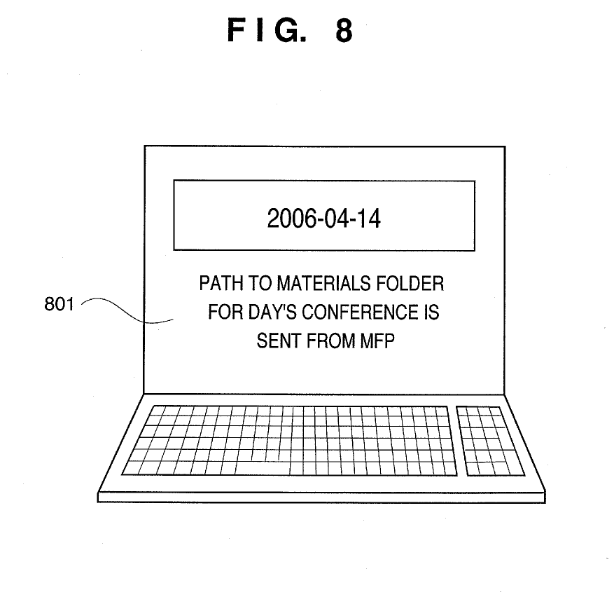

Step S108: The MFP 200 sends e-mail, in which the path (URI) for accessing the shared folder is set forth, to the personal computer 20 connected to the network (LAN 40). FIG. 8 is a diagram schematically illustrating the manner in which mail is transmitted to the personal computer 20 connected to a network. As indicated at indicated at 801, the path of the materials folder for the conference on that day is sent from the MFP 200 to the personal computer 20. Thus, a user for which it has been determined that printing is not required is notified by the MFP 200 of address information indicating the location in the storage device at which the document has been stored.

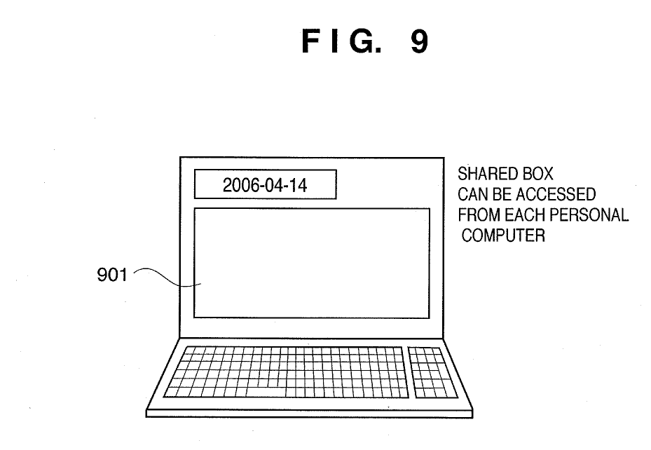

Step S109: The participant opens the received e-mail and, by clicking, is capable of accessing the shared folder. For example, control is possible in which the path to the shared folder is embedded in the e-mail as a hyperlink, thereby allowing the user to access the shared folder by clicking on the path. Alternatively, the user can access the shared folder by directly inputting the path to the folder in file browsing software. FIG. 9 is a diagram schematically illustrating the manner in which the personal computer 20 of the participant is capable of accessing a shared folder. As shown in FIG. 9, a display area 901 displays the conference-materials data, which has been placed in the shared folder, in the form of a list.

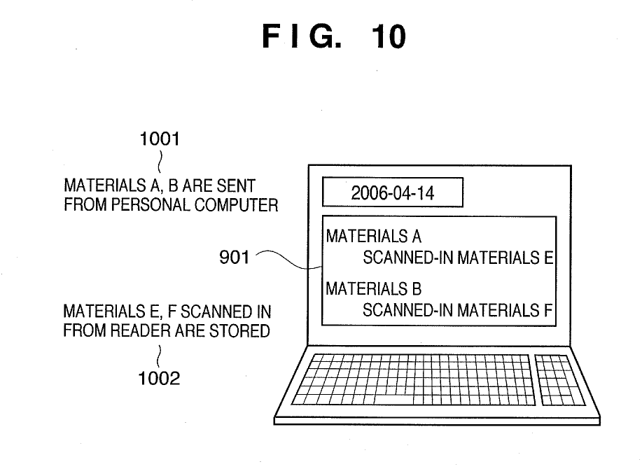

Step S110: By way of the operation performed at step S109, the conferee connects his or her personal computer to the network and can access the shared folder. This means that as the result of an individual who has prepared conference materials placing these materials in the shared folder, another participant who has connected his or her personal computer can also refer to the materials in the folder. FIG. 10 is a diagram schematically illustrating the manner in which conference materials are placed in a shared folder. Reference numeral 1001 in FIG. 10 indicates the manner in which materials A, B have been sent to the shared folder from the personal computer 20 connected to the network. As a result, the materials A, B are being displayed in the display area 901. After the processing of step S110, control proceeds to step S111.

Step S111: The MFP 200 determines whether or not printing is required with regard to materials that have been registered in the box at step S110. The determination is based upon the selection made by the conferee at step S105 as to whether printing is required or not. Specifically, with regard to the conference materials registered in the box at step S110, if there is even a single item for which printing has been selected as being necessary, then printing is determined to be necessary (“YES” at step S111) and control proceeds to step S112. If there is not even a single item of conference materials for which printing has been selected as being necessary, then printing is determined to be unnecessary (“NO” at step S111) and control proceeds to step S113.

Step S112: On the basis of whether or not printing of materials is required or not as selected at step S105, the MFP 200 executes printing of the number of copies deemed necessary for printing. Control then proceeds to step S113.

Step S113: As mentioned above, the conferee can bring in his or her personal computer, connect it to the network and access the shared folder. The individual who has prepared the conference materials therefore reads in the conference materials using the reader (scanner) of the MFP 200 and places them in the shared folder in the form of electronic information, thereby enabling other participants who have connected their personal computers to consult the materials in the folder. In FIG. 10, reference numeral 1002 indicates the manner in which materials E, F have been read by the reader and saved in the shared folder. The materials are being displayed in the display area 901 as a result. Control proceeds to step S114 following the processing of step S113.

Step S114: The MFP 200 determines whether or not printing is required with regard to materials that have been registered in the box at step S113. The determination is based upon the selection made by the conferee at step S105 as to whether printing is required or not. Specifically, with regard to the conference materials registered in the box at step S113, if there is even a single item for which printing has been selected as being necessary, then printing is determined to be necessary (“YES” at step S114) and control proceeds to step S115. If there is not even a single item of conference materials for which printing has been selected as being necessary, then printing is determined to be unnecessary (“NO” at step S114) and processing is exited.

Step S115: On the basis of whether or not printing of materials is required or not as selected at step S105, the MFP 200 executes printing of the number of copies deemed necessary for printing. Processing is then terminated.

In a case where further conference materials (document data) are registered after execution of print processing, the number of copies of conference materials to be printed is further determined, based upon the selection as to whether or not printing is required, by the time these new conference materials are registered. Processing for printing the number of copies determined anew is executed based upon the newly input conference materials. As a result, in a case where new conference materials are added on after the earlier conference materials are printed and distributed, printing of a sufficient number of copies of the newly added materials can be performed without requiring that the conference organizer perform a complicated operation. Thus, the implementation according to this embodiment determines whether printing based upon document data that has been stored in a storage device is necessary or not on a per-authenticated-user basis and, based upon the determination, decides the number of copies of document data to be printed.

(Flow of Printing of Materials)

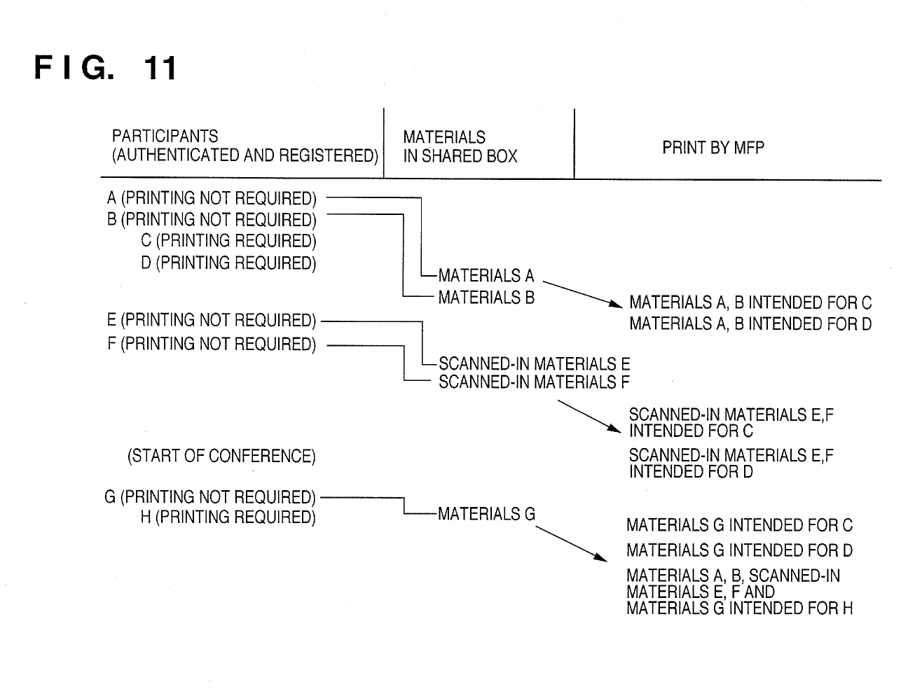

An example of operation according to the flow described above will be described with reference to FIG. 111. FIG. 11 is a diagram schematically illustrating the flow of printing of materials executed by the arrangement according to this embodiment.

In the example of FIG. 11, at the time of authentication, participants A and B indicate that printing of conference materials is not required, and participants C and D indicate that printing is required. Participants E and F indicate that printing is not required. On the basis of these requests, the MFP 200 creates a list recorded with regard to the mail addresses recorded on the authentication cards and whether or not printing is required, as illustrated in FIG. 7. It should be noted that with regard to a participant whose mail address has not been stored on the authentication card, the mail address section is blank and the fact that printing is required is selected automatically. The reason why participants A, B, E and F do not require printing to be performed is that is that these participants have brought their own personal computers. These personal computers are connected to the network and make it possible to view the conference materials by accessing the shared folder.

Participants A and B prepare conference materials in the form of electronic information and places materials A and B, respectively, in the shared folder beforehand. In response, the MFP 200 prints the materials A and B for the sake of participants C and D, who have applied for the need to have the materials printed.

Participants E and F have stated that printing is unnecessary and have brought conference materials in the form of paper. Accordingly, participants E and F have the reader of the MFP read in their own materials and place the read materials E and F in the shared folder. In response, the MFP 200 prints the materials E and F, which have been registered in the shared folder anew, for the sake of participants C and D, who have applied for the need to have the materials printed.

Assume that the conference begins at this point in time. After the conference starts, participants G and H enter the conference room and make their applications. With regard to applications for printing, participant G states the printing is not required, while participant H states that printing is required.

Participant G prepares the materials in the form of electronic materials and places them in the shared folder. Participant G participates in the conference using materials A, B, the scanned-in materials E, F and own prepared materials G, all of which are in the shared folder. In response, for participants C and D, the MFP 200 prints out materials G that were placed in the folder subsequently. Further, for participant H, the MFP 200 prints out materials A, B, scanned-in materials E, F and materials G.

By virtue of this print processing, participants A, B, E, F and G, who have stated that printing is not required, go to the shared folder to make reference to the materials A, B, scanned-in materials E, F and materials G, which have been placed in the folder. Participants C, D and H, who have applied for the need to have the materials printed, participate in the conference upon acquiring, in the form of paper, the materials A, B, scanned-in materials E, F and materials G printed on paper.

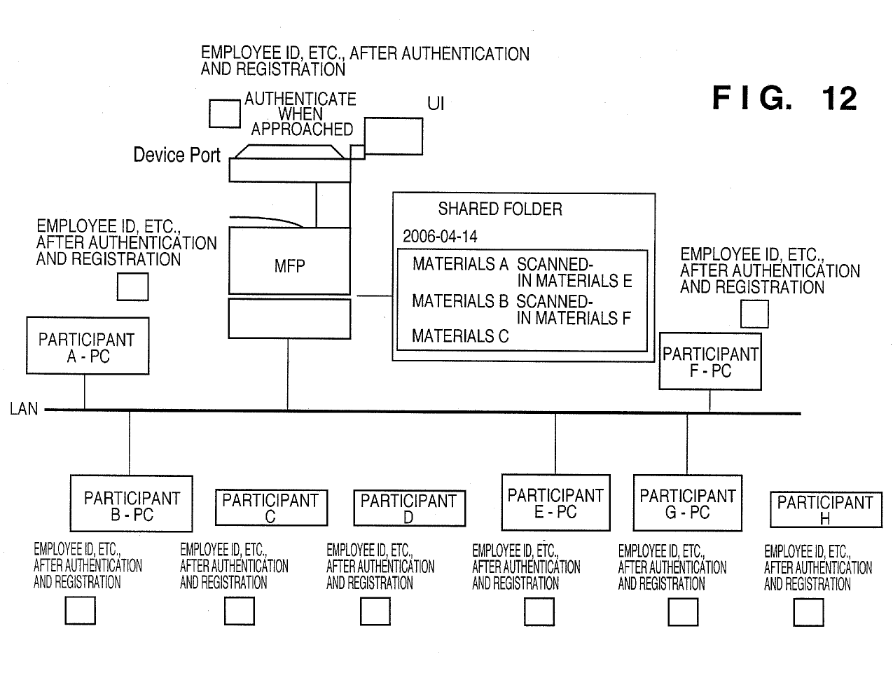

FIG. 12 is a diagram is a diagram schematically illustrating the relationship between participants A, B, E, F, G who have brought their personal computers and connected them to the network, and participants C, D, H who do not possess personal computers. At the center of this relationship is the MFP 200.

In the arrangement according to this embodiment, as described above, a selection as to whether or not the printing of conference materials is required is accepted from conferees, the number of copies of conference materials to be printed is determined based upon the selection and the conference materials are printed in the amount necessary. Further, control is exercised in such a manner that a folder in which the conference materials have been placed can be referred to from a device connected to a network. In accordance with the arrangement of this embodiment, therefore, conference materials can be prepared in the amount necessary without requiring that the conference organizer perform a complicated operation.

Further, since the MFP 200 has a scanner, a conferee can register conference materials using a hard copy, as described above. Further, since the MFP 200 is connected to a network and exercises control in such a manner that a folder can be accessed from an external apparatus, a conferee can register conference materials via the network.

Further, since the MFP 200 uses e-mail to notify a personal computer connected to the network of the path to a created folder, a conferee who has brought his or her personal computer can readily access conference materials that have been placed in the folder.

In a case where further conference materials have been registered after execution of print processing, the number of copies of conference materials to be printed is further determined, based upon the selection as to whether or not printing is required, by the time these new conference materials are registered. Processing for printing the number of copies determined anew is executed based upon the newly input conference materials. As a result, in a case where new conference materials are added on after the earlier conference materials are printed and distributed, printing of a sufficient number of copies of the newly added materials can be performed without requiring that the conference organizer perform a complicated operation.

### Other Embodiments

It can be so arranged that printing is started using a predetermined event as a trigger. For example, it can be so arranged that printing is started in response to the arrival of a preset time. If this arrangement is adopted, printing can be started automatically in conformity with the date and time of a conference, thereby making it possible to further lighten the load on the conference organizer.

By way of example, printing start time can be stored in the function determining timer 1620 (FIG. 3) that manages the time of scheduled functions. If the starting time of the conference is 10:00 AM, for example, then printing can be set to start at 9:55 AM. The conference organizer previously processes the applications for admittance to the conference and for printing by 9:55 AM, and communicates the fact that individuals who have prepared conference materials will place electronic information and paper materials, etc., in the shared folder by this time.

A participant places materials in the folder by the time printing starts. In a case where materials A, B, E, F and G mentioned in the first embodiment are placed in the folder and the printing start time (9:55 AM) arrives, printing starts. At this time materials are printed for participants C, D and H who have indicated that printed materials are required. Although it is not illustrated, distribution of materials is prepared by appending the names of participants C, D, H, who have requested printing, to the printed materials.

Although an embodiment of the present invention has been described in detail above, it is possible for the invention to take on the form of a system, apparatus, program or storage medium. More specifically, the present invention may be applied to a system comprising a plurality of devices or to an apparatus comprising a single device.

It should be noted that there are cases where the object of the invention is attained also by supplying a program, which implements the functions of the foregoing embodiments, directly or remotely to a system or apparatus, reading the supplied program codes with a computer of the system or apparatus, and then executing the program codes.

Accordingly, since the functions of the present invention are implemented by computer, the program codes per se installed in the computer also fall within the technical scope of the present invention. In other words, the present invention also covers the computer program itself that is for the purpose of implementing the functions of the present invention.

In this case, so long as the system or apparatus has the functions of the program, the form of the program, e.g., object code, a program executed by an interpreter or script data supplied to an operating system, etc., does not matter.

Examples of storage media that can be used for supplying the program are a floppy (registered trademark) disk, hard disk, optical disk, magneto-optical disk, CD-ROM, CD-R, CD-RW, magnetic tape, non-volatile type memory card, ROM, DVD (DVD-ROM, DVD-R), etc.

As for the method of supplying the program, a client computer can be connected to a website on the Internet using a browser possessed by the client computer, and the computer program per se of the present invention or a compressed file that contains an automatic installation function can be downloaded to a recording medium such as a hard disk. Further, the program of the present invention can be supplied by dividing the program code constituting the program into a plurality of files and downloading the files from different websites. In other words, a WWW server that downloads, to multiple users, the program files that implement the functions of the present invention by computer also is covered by the present invention.

Further, it is also possible to encrypt and store the program of the present invention on a storage medium such as a CD-ROM, distribute the storage medium to users, allow users who meet certain requirements to download decryption key information from a website via the Internet, and allow these users to run the encrypted program by using the key information, whereby the program is installed in the user computer. Further, besides the case where the aforesaid functions according to the embodiment are implemented by executing the read program by computer, an operating system or the like running on the computer may perform all or a part of the actual processing so that the functions of the foregoing embodiment can be implemented by this processing.

Furthermore, after the program read from the storage medium is written to a memory provided in a function expansion board inserted into the computer or a function expansion unit connected to the computer, a CPU or the like mounted on the function expansion board or function expansion unit performs all or a part of the actual processing so that the functions of the foregoing embodiment can be implemented by this processing.

In accordance with the present invention, it is possible to provide a technique whereby it is made possible to print the necessary number of copies of documents without requiring troublesome labor even in a case where the required number of documents is unknown.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-309628, filed Nov. 15, 2006, which is hereby incorporated by reference herein in its entirety.

What is claimed is:

1. A printing apparatus having a printing device for executing print processing based upon document data, comprising:
an input unit adapted to input document data;
a storage control unit adapted to store the input document data in a storage device;
an authentication unit adapted to authenticate a user;
a determination unit adapted to determine, for every user authenticated by said authentication unit, whether or not it is necessary to perform printing based upon the document data that has been stored in the storage device;
a decision unit adapted to decide the number of copies of document data to be printed, based upon the determination made by said determination unit; and
a printing control unit adapted to cause the printing device to execute printing of the decided number of copies with regard to the document data that has been stored in the storage device.

2. The apparatus according to claim 1, further comprising a scanner unit adapted to optically read a document and acquire image data;
wherein said input unit inputs the image data, which has been acquired in said scanner unit, as document data.

3. The apparatus according to claim 1, further comprising a communication unit adapted to communicate with an external apparatus connected to a network;
wherein said input unit inputs document data from the external apparatus via said communication unit.

4. The apparatus according to claim 1, further comprising a notification unit adapted to give notification of location information, which indicates a location in the storage device at which the document has been stored, to a user for which it has been determined that printing is not necessary.

5. The apparatus according to claim 4, further comprising:
a reading unit adapted to read user identification from an identification medium on which the user identification information has been stored; and
a display unit adapted to display information to be presented to the user;
wherein said authentication unit performs user authentication by acquiring the user identification information by said reading unit;
said display unit displays a screen for allowing the user to select whether or not printing is necessary in response to reading of the identification information by said reading unit;
said determination unit determines whether or not printing is necessary and determines a destination of notification by said notification unit in accordance with operation by the user on a screen, which is displayed by said display unit, for allowing selection of whether or not printing is necessary; and
in a case where said determination unit has determined that printing is not necessary, said notification unit notifies the notification destination corresponding to the identification information by giving notification of the location information.

6. The apparatus according to claim 1, wherein said printing control unit exercises control in such a manner that the printing device is caused to start the print processing in response to arrival of a preset time.

7. The apparatus according to claim 1, wherein if further document data is input to said input unit after execution of the print processing, then:
said decision unit decides a further number of copies of document data to be printed, based upon the determination by said determination unit as to whether or not it is necessary to print the documents, by the time the further document data is input; and
said printing control unit causes the printing device to print the further decided number of copies based upon the further input of document data.

8. A method of controlling a printing apparatus having a printing device for executing print processing based upon document data, said method comprising:
inputting document data;
storing the input document data in a storage device;
authenticating a user;
determining, for every authenticated user, whether or not it is necessary to perform printing based upon the document data that has been stored in the storage device;
deciding the number of copies of document data to be printed, based upon the determination; and
causing the printing device to execute printing of the decided number of copies with regard to the document data that has been stored in the storage device.

9. A program, which has been stored on a computer-readable storage medium, for causing a computer to function as the printing apparatus set forth in claim 1.

10. A computer-readable storage medium on which the program set forth in claim 9 has been stored.
